(19) United States
(12) Patent Application Publication
(10) Pub. No.: US 2004/0137926 A1
(43) Pub. Date: Jul. 15, 2004

(54) Frequency searching method and apparatus in mobile communications

(75) Inventor: Hyeoun-Joo So, Gyeonggi-Do (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/743,296

(22) Filed: Dec. 23, 2003

(30) Foreign Application Priority Data
Dec. 31, 2002 (KR) 88348/2002

(51) Int. Cl. H04B 7/00; H04Q 7/20

(52) U.S. Cl. 455/509; 455/456.1

(57) ABSTRACT

A frequency searching method and apparatus is provided for a mobile communication system. This may involve transmitting frequencies allocated to service vendors in a System Information Block (SIB). The frequency data in the SIB may be received by a User Equipment (UE). The UE may store the frequency data in an internal memory. A cell search may be performed about frequencies of a pertinent service vendor stored in the internal memory. When the cell search is finished and a communication channel is connected, frequency data may be received by service vendors from the SIB, the stored frequency data may be updated and the updated frequency data may be used in a next cell search. It may then be possible to quickly search frequencies allocated by service vendors. Accordingly, a cell search time and a registration time can be reduced.

The present application claims priority from Korean Patent Application No. 88348/2002 filed Dec. 31, 2002, the subject matter of which is incorporated herein by reference.

### BACKGROUND OF THE INVENTION

1. Field of the Invention

Embodiments of the present invention relate to mobile communications. More particularly, embodiments of the present invention relate to a cell searching method for a mobile communication terminal.

2. Background of Related Art

With the rapid progress of mobile radio communication techniques, the number of mobile radio communication terminals has greatly increased. However, when transmitting a quantity of data greater than voice communication data to a mobile radio telephone through a radio connection network, a mobile radio communication system may not be able to keep up with wire communication systems. IMT-2000 is one communication system to perform a large quantity of data communication.

Universal Mobile Telecommunications System (UMTS) is a third generation mobile communication system. European IMT-2000 system is developed from Global System for Mobile (GSM) communication. UMTS has as a goal to provide more improved mobile communication service based on GSM core network and Wideband Code Division Multiple Access (WCDMA) techniques.

### SUMMARY OF THE INVENTION

Embodiments of the present invention may provide a frequency searching method for a mobile communication terminal capable of managing frequency bands more efficiently when performing cell searching for a global roaming service.

Embodiments of the present invention may provide a frequency searching method capable of quickly and efficiently searching frequencies of several service vendors.

Embodiments of the present invention may include receiving system information from a network, obtaining a usage frequency of each service vendor from the received system information, storing the usage frequency, and searching the stored frequencies.

Embodiments of the present invention may further include performing a cell search of pre-stored frequencies of pertinent service vendors.

A usage frequency of each service vendor may be stored in an internal memory of user equipment (UE).

The system information may be included in a System Information Block (SIB). The SIB, including a usage frequency of each service vendor, may be transmitted through a Broadcast Control Channel (BCC).

Embodiments of the present invention may include performing a cell search by frequency bands when a requested frequency is not found in the stored frequencies of the pertinent service vendor.

The pre-stored frequencies may be updated by receiving the system information from the network.

Embodiments of the present invention may include receiving usage frequency of service vendors from a network and storing the received frequency data in a UE (user equipment). A cell search of the pre-stored frequencies of pertinent service vendors may be performed in a frequency search. A cell search may again be performed by frequency bands when a requested frequency is not found in the pre-stored frequencies of the pertinent service vendor.

The usage frequency may be transmitted through a System Information Block (SIB). The network may be a Radio Resource Control (RRC) of a UTRAN. The SIB may be transmitted through a BCCH.

Embodiments of the present invention may further include updating pre-stored frequencies by receiving system information from the network.

Additional advantages, objects, features and embodiments of the present invention will be set forth in part in the description that follows and in part will become apparent to those having ordinary skill in the art upon examination of the following or may be learned from practice of the invention.

### BRIEF DESCRIPTION OF THE DRAWINGS

The following represents brief descriptions of the drawings in which like reference numerals represent like elements and wherein:

FIG. 1 is a block diagram illustrating a Universal Mobile Telecommunications System (UMTS) network according to an example arrangement;

FIG. 2 is a schematic view illustrating a UMTS radio access interface protocol according to an example arrangement; and

FIG. 3 is a flowchart illustrating a frequency searching method according to an example embodiment of the present invention.

### DETAILED DESCRIPTION OF PREFERRED EMBODIMENTS

FIG. 1 shows a network structure of a UMTS according to an example arrangement. Other arrangements are also possible. The UMTS includes a user equipment (UE) 30, a UMTS terrestrial radio access network (UMTS) 20 and a core network (CN) 10. The UTRAN 20 may include at least one Radio Network Sub-system (RNS) 21. Each RNS 21 may include a radio network controller (RNC) 22 and at least one node-B (base station) 23.

The RNC 22 may allocate and manage radio resources, as well as perform an access point function to the CN 10. The node-B 23 may perform an access point function between the UE 30 and the UTRAN 20 by receiving information from a physical layer of the UE 30 in an upward link and transmitting data to the UE 30 in a downward link.

One function of the UTRAN 20 is to construct and maintain a Radio Access Bearer (RAB) for communication between the UE 30 and the CN 10. The CN 10 may apply quality of service (QoS) requirements of end-to-end for the RAB. The RAB may support the QoS requirement set by the CN 10. Accordingly, the UTRAN 20 may satisfy the QoS requirement of end-to-end by constructing and maintaining the RAB.

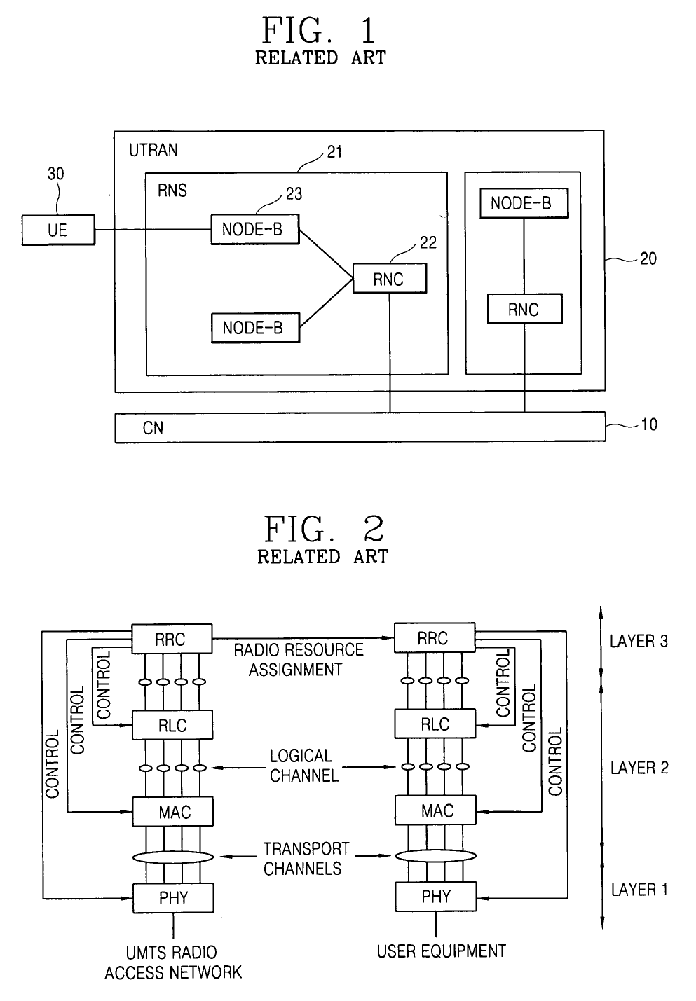

FIG. 2 is a schematic view illustrating a radio access interface protocol of the UMTS according to an example arrangement. Other arrangements are also possible.

In the UMTS, the radio access interface protocol between the UE 30 and the UTRAN 20 may be based on a radio access network standard of 3GPP (third generation partnership project) and use an Open System Interconnection (OSI) standard model widely known in communication systems as a reference model.

As shown in FIG. 2, a Radio Resource Control (RRC) layer may be arranged at a top portion of a plurality of UMTS radio protocols and be related to setting, resetting and release of Radio Bearer (RBs). The RRC layer may control a transmission channel and a physical channel. The RB may correspond to a service provided for data transmission between the UE 30 and the UTRAN 20. In general, the RB setting corresponds to a process for defining protocol layers and channel characteristics required for a certain service and setting for each detailed parameter and operation method.

The UMTS has as a goal to provide a wideband service and a global roaming service. The UMTS may have a same standard and use a frequency in a same band all over the world.

In the UMTS, in order to provide the roaming service, a frequency band may be fixed and adjusted by each service vendor. Accordingly, the UE 30 may scan a frequency band allocated to each service vendor, store a cell-searched (frequency scan) frequency in a NV Random Access Memory (RAM) and use the stored frequency information in a next cell search.

In order to provide a global roaming service for the UMTS, a full scan may be needed. In the UMTS, in order to provide the global roaming service, the UE may fully scan a frequency band allocated to each service vendor. This may delay a cell search time.

However, accuracy may be lowered in the cell search by using frequency information obtained from previous cell searches. Accordingly, in order to provide a global roaming service in the UMTS, more efficient band management may be needed.

Embodiments of the present invention may provide a method for searching frequencies allocated to service vendors. A Radio Resource Control (RRC) layer in a UMTS Terrestrial Radio Access Network (UTRAN) may construct a System Information Block (SIB) by associating frequency information with each service vendor and transmitting the information to the UE 30 through a Broadcast Control Channel (BCCH).

The UE 30 may obtain the frequency of each service vendor from the received SIB. The UE 30 may store the information in an internal memory and use the frequency in a next frequency scan. In this discussion, a frequency of each service vendor is considered to have already been stored in an internal memory.

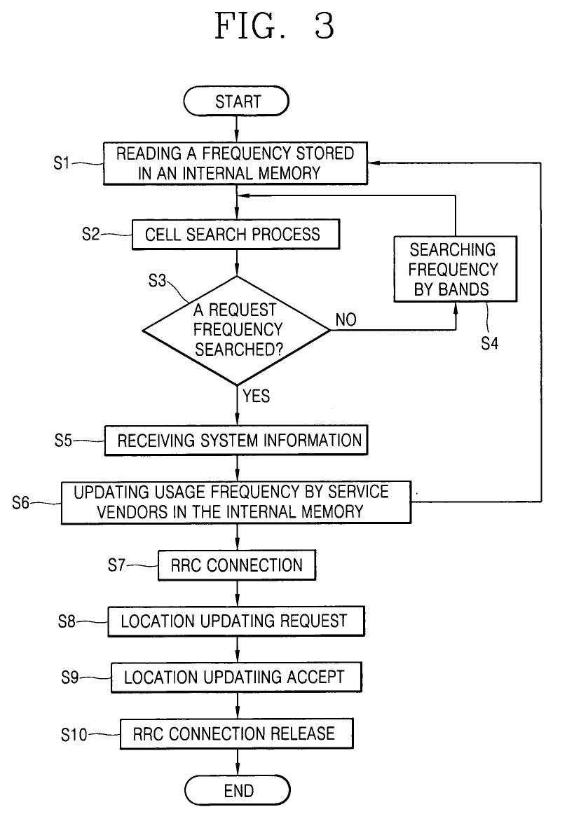

FIG. 3 is a flowchart illustrating a frequency searching method according to an example embodiment of the present invention. Other operations, orders of operations and embodiments are also within the scope of the present invention.

The UE 30 may search an appropriate cell when a user turns on the power of the UE 30. In order to search the appropriate cell, the UE 30 may read a frequency stored in an internal memory as shown in block S1. The UE may perform a cell search process about the frequency of the pertinent service vendor as shown in block S2.

In order to search the frequency of the pertinent service vendor stored in the memory, the UE 30 may search using a slot synchronous methodology by using a first synchronization code of a Synchronization Channel (SCH) and recognize a frame synchronous and a code group ID using a second synchronization code. When using the slot synchronization methodology, frame synchronization and code group recognition may be normally performed. The UE 30 may search a frequency and access a communication channel through a process for recognizing a pertinent scrambling code from a plurality of scrambling codes of a recognized code group.

In block S3, a determination is made whether a requested frequency is found among the stored frequencies of the pertinent service vendor. When the requested frequency is not found, the UE 30 may search frequencies by bands as shown in block S4.

When a communication channel is connected between the network 20 and the UE 30, the UE 30 may receive system information through the BCCH channel as shown in block S5. The UE 30 may update a service vendor usage frequency of each service vendor stored in the memory as shown in block S6. The updated frequency in the memory may be used for a next frequency scan. The UE 30 may perform a cell search about a frequency band of a pertinent service vendor rather than about all frequency bands. Accordingly, embodiments of the present invention may reduce a cell search time.

Afterward, in the communication connection state, a call originating or call incoming is requested, a RRC as a protocol entity of the UE 30 transmits a RRC connection request message to the UTRAN 20 through a Random Access Channel (RACH). The UTRAN 20 may transmit a RRC connection setup message to the UE 30 through a Forward Access Channel (FACH). Accordingly, the UE 30 may perform a RRC connection setup according to the RRC connection setup message. The UE 30 may transmit a RRC connection setup complete message to the UTRAN 20 through a Dedicated Channel (DCH).

Accordingly, when the UE 30 successfully transmits the RRC connection setup message, the UE 30 may be RRC-connected with the UTRAN 20. The UE 30 may perform state transition to a connected mode receivable/transmittable user traffic as shown in block S7.

Afterward, the UE 30 may perform a location updating request to the UTRAN 20 as shown in block S8. When the UTRAN 20 checks the current location of the UE 30 and transmits the current location information, the UE 30 may update location information and notify the UTRAN 20 of a location updating accept as shown in block S9. In block S10, the RRC connection may be released. Accordingly, the registration of global roaming service may be finished.

When a channel error or communication ends in the communication connection state, the RRC acts as a protocol entity of the UE 30 and transmits a RRC connection release message to the UTRAN 20 through the DCH. The UTRAN 20 may release call connection for communication by transmitting a RRC connection release complete message to the UE 30 through the DCH as shown in block S10.

As described above, frequency information allocated to service vendors may be received by the UE as a SIB. This information may be stored in an internal memory of the UE. A channel may be searched about the stored frequencies so that it is possible to quickly search frequencies. Accordingly, it is possible to improve a cell search operation and reduce a registration time.

Embodiments of the present invention may include a mobile communication device having a receiving/transmitting device to receive and transmit information with a network and a memory to store information (such as usage information of service vendors). A processing device may also perform various operations as discussed above including obtaining a usage frequency of service vendors, performing a cell search of frequencies stored in memory and updating the memory.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A frequency searching method comprising:
receiving system information from a network;
obtaining a usage frequency of each service vendor from the received system information; and
searching a frequency based on the obtained usage frequency.

2. The method of claim 1, wherein the system information is received by a mobile communication terminal from the network.

3. The method of claim 1, wherein searching the frequency comprises performing a cell search of frequencies of a service vendor.

4. The method of claim 1, further comprising storing the usage frequency of each service vendor in memory of user equipment.

5. The method of claim 1, wherein receiving the system information comprises receiving the system information in a system information block.

6. The method of claim 5, further comprising transmitting the system information block including the usage frequency of each service vendor.

7. The method of claim 1, wherein the system information is received from the network through a broadcast control channel.

8. The method of claim 1, further comprising:
performing a cell search by frequency bands when a requested frequency is not found when searching frequencies.

9. The method of claim 1, further comprising:
updating stored frequencies based on the received system information from the network.

10. A frequency searching method comprising:
receiving usage frequency data of at least one service vendor from a network;
storing the received usage frequency data in user equipment;
performing a cell search of a stored frequency of a pertinent service vendor in a frequency search; and
performing another cell search by frequency bands when a frequency is not found in the stored frequencies of the pertinent service vendor.

11. The method of claim 10, wherein the user equipment comprises a mobile communication terminal.

12. The method of claim 10, further comprising transmitting the usage frequency from the network through a system information block.

13. The method of claim 12, wherein the system information block is transmitted through a broadcast control channel.

14. The method of claim 10, wherein the network comprises a Radio Resource Control of a UMTS Terrestrial Radio Access Network.

15. The method of claim 10, further comprising:
updating stored frequencies based on received system information from the network.

16. A mobile communication apparatus comprising:
a receiving device to receive system information;
a memory to store information regarding service vendors; and
a processing device to obtain a usage frequency of a particular service vendor from the memory.

17. The apparatus of claim 16, wherein the system information comprises usage information of service vendors.

18. The apparatus of claim 16, wherein the processing device performs a cell search of frequencies of service vendors stored in the memory.

19. The apparatus of claim 16, wherein the receiving device receives the system information in a system information block.

20. The apparatus of claim 16, wherein the receiving device receives the system information from a network through a broadcast control channel.

21. The apparatus of claim 16, wherein the processing device performs a cell search based on frequency bands when searching the frequencies stored in the memory.

22. The apparatus of claim 16, wherein the processing device updates stored frequencies in the memory based on received system information from the network.
